(19) United States
(12) Patent Application Publication
(10) Pub. No.: US 2004/0172338 A1
(43) Pub. Date: Sep. 2, 2004

(54) Riskless contingent order matching

(76) Inventors: Daniel J. Spoonhower, Pittsburgh, PA (US); Daniel P. Huttenlocher, Ithaca, NY (US); Brian M. Freyburger, New York, NY (US); William J. Rucklidge, Mountain View, CA (US); Walter W. Bell, San Francisco, CA (US)

Correspondence Address: Stephen C. Durant, Morrison & Foerster LLP, 425 Market Street, San Francisco, CA, 94105-2482, US

(21) Appl. No.: 10/378,162

(22) Filed: Feb. 28, 2003

Related U.S. Application Data
(60) Provisional application No. 60/453,698, filed on Feb. 27, 2003.

(51) Int. Cl. G06F 17/60

(52) U.S. Cl. 705/26

(57) ABSTRACT

A computer-implemented method of matching orders comprising: defining a first order for a first item; defining a second order for a second item; defining at least one condition applicable to combined execution of the first and second orders; wherein the at least one condition sets forth a required proportionality measure as between the first order and the second orders; defining a prioritization of first and second orders; and submitting to an electronic marketplace at most one at a time of a new order of only an item of the first order or only an item of the second order: wherein execution of both the first order and the second order meets the conditions applicable to the execution of the first and second orders; and wherein execution of both the first order and the and second order is contingent upon the execution of the at least one order submitted over the electronic marketplace.

### BACKGROUND OF THE INVENTION

Electronic communication networks (or ECNs) serve as an electronic mechanism for transmitting, processing, and executing orders. An order typically involves a request from a client to a broker to buy (buy order) or to sell(sell order) a specified amount of a particular item (e.g., security or commodity) at a specific price or at the market price. An ECN is an electronic system that brings buyers and sellers together for the electronic execution of trades. It typically disseminates information to interested parties about the orders entered into the network and allows these orders to be executed. ECNs represent orders in NASDAQ stocks; they internally match buy and sell orders or represent the highest bid prices and lowest asking prices on the open market. The benefits an investor gets from trading with an ECN include after-hours trading, avoiding market makers (and their spreads), and anonymity (which is often important for large trades).

Current ECNs, however, generally implement only a very simple matching process. For example, upon receiving an order to sell 1000 shares of common stock at $25 or more, the ECN will look for current bids at $25 or less. If such an order is found, then the ECN creates an execution between the two orders. If there is no current order that meets those criteria, then the offer is added to the list of current orders and the next new order is accepted and the process repeats.

Traditional ECNs are examples of electronic order handlers: they accept orders, compare them to previously accepted orders and execute trades when appropriate. Most ECNs do not accept orders that include more than one security. Those that do, do not enforce contingencies among those securities; each security is effectively treated as a separate order.

While this process is appropriate for equity trading, some types of instruments, for example convertible shares, may require more complicated handling.

A contingent order is an order in which multiple securities are being bought and sold simultaneously. If an execution is created for any one of the securities, then the placer expects executions for one or more of the remaining securities. Contingent orders already exist in many marketplaces, but they are handled through a manual process. Due to the difficulties of tracking the contingencies from several orders simultaneously while monitoring changing market conditions, these human handlers often take risks in processing contingent orders. They offer riskless execution to the other participants by accepting that risk themselves.

In the section below, we consider an example of a contingent order known as a swap order. A swap order is an order which designates the placer's intention to buy one security while selling another at the same time. The placer is willing to accept a range of prices for each security, so long as the net cash received or lost in the transaction is maintained. Also, many placers will accept partial executions, as long as the ratio between the quantities of the two securities stays the same.

Another example of a contingent order is known as a pinned order. In such an order, only one security is being traded. Again, the price constraint of the order is not a fixed value, but rather, the price is pinned to the price of another security and moves with it. For example, corporate bonds are frequently traded with their prices pinned to the price of some treasury bond. In this case, no treasury bond are being exchanged, but the price of the corporate bond cannot be computed without knowing the current value of the treasury bond. A third example of a contingent order is a basket order. Here, an order may include constraints to buy and/or sell many securities, however, the price of each security is fixed at the time the order is placed. The contingencies of both pinned and basket orders are actually a subset of the constraints imposed by a swap order, and are handled by the process described below. Though pinned and basket orders exist today, the process described in this document provides more efficient and riskless execution than is currently practiced.

As used herein, riskless means that throughout execution of an order a participant is exposed to more risk than either 1) the risk the participant was exposed to before placing the order or 2) the risk the participant is exposed to after the order is completely executed. In the contingent swap case, the expectation is that the overall value of the participant's portfolio remains unchanged throughout the transaction (at least with respect to the execution of the order). It is easy to see, however, if one security was purchased without the other being sold that the value of the participant's portfolio would be changed significantly and that the participant would be exposed to new risks caused by market shifts.

### BRIEF DESCRIPTION OF THE DRAWINGS

FIGS. 1A-1D are illustrative flow diagrams showing the operation of a computer program based process in accordance with one embodiment of the invention.

FIG. 2 is an illustrative block diagram of one system in which the invention can be implemented.

FIG. 3 is an illustrative block diagram of an alternative system in which the invention can be implemented.

### DETAILED DESCRIPTION OF THE PREFERRED EMBODIMENT

The following description is presented to enable any person skilled in the art to make and use the invention, and is provided in the context of particular applications and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the are would realize that the invention might be practiced without the use of these specific details. In other instances, well known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

Many financial marketplaces have evolved beyond manual execution processes and use electronic mechanisms to handle and process orders. As used herein, an electronic marketplace comprises a computer system which accepts orders over an electronic network, stores orders on computer-readable media and computes matches electronically. It may also transmit current open orders (ranked appropriately) via a network as well as records of past orders and trades previously stored on its media. Marketplaces maybe open to any and all participants or only to select members. Also, they maybe symmetric (in that all participants are treated equally) or asymmetric (in that some participants are treated specially). Many symmetric marketplaces are anonymous (in that the identity of other participants are hidden even after a trade occurs). Participant identity is one of the more important aspects of an asymmetric marketplace: the privileged participant(s) may be sole holders of the identities of all other participants. Examples of electronic marketplaces include exchanges, both open and member-based (exchanges typically charges fees per transaction or for membership). Electronic marketplaces may also take the shape of a broker/dealer that transmits its markets and accepts orders from its customers electronically. In this later case, the marketplace may be used as a tool to facilitate communication, manage orders, automatically execute trades, and analyze results.

Rather than requiring each order to be considered by a specialist, these electronic communication networks (ECNs) accept orders, compare them to previously accepted orders and create new executions if possible.

In the past, ECNs and other electronic marketplaces have only accepted relatively simple orders and have used a simple comparison mechanism to determine when new executions are possible. Electronic Riskless Contingent Order Matching defines a process that accepts more complicated orders (e.g. swap orders) and handles any contingencies necessary to complete a match without exposing any party to additional risk.

An order handler, automatic or otherwise, which accepts contingent orders must have a mechanism for dealing with incompatibilities among these contingencies. The simplest such mechanism is so do nothing: to consider all such incompatibilities unresolvable. More effective handlers, known as contingent order matchers, will have more effective methods of handling these situations.

The Riskless Contingent Order Matcher of a present embodiment of the invention deals with these incompatibilities by routing residual, non-contingent orders to a traditional electronic marketplace. As executions are returned from this external market, corresponding executions are created for the contingent orders. It will be appreciated that routing is a traditional part of this type of trading. However, it is usually done at the granularity of an entire order. One advantage of one aspect of the present invention is it can maintain the balance at the level of partial fills returned from the external market. This typically is not done currently at least in part because of the computational overhead of ensuring all of the constraints (e.g. proportionality between securities, total cash spent in the transaction) at each step of the execution.

As an example, consider two complementary convertible orders, one to buy and one to sell. Say, however, that the first order is actually a swap order: its convertible purchase is contingent upon the sale of some amount of the underlying equity. An execution between these two convertible orders is therefore also contingent upon this sale of equity (since the placer of the second convertible order is unwilling to offer any).

To be concrete, say the first is an order to purchase 1,000 convertible shares and sell 2,000 common shares, while the second order is only to sell 1,000 convertible shares. Finally, say that participants expect to spend $6,000 and receive $10,000 (respectively) in this transaction. In this case, the residual order is an offer to sell 2,000 common shares. Furthermore, these shares must be sold at a price of at least $2 each. Note that if all 2,000 of the residual shares are sold at a price of $2, then 1,000 convertible shares may be executing between the two orders at a price of $10 per share. The first participant spends $6,000 (the $10,000 required for the convertible shares is offset by the $4,000 gained in the common execution) and the second participant receives $10,000.

In the above example, both participants would expect to be protected from risks introduced either by execution of less than 2,000 of the residual shares or by allowing one of the contingent orders to be retracted without canceling the residual order.

Note that the example in the section focused only on those orders involving one or two securities. The Intelligent Markets contingent order matcher is able to handle orders each involving an arbitrary number of securities, as long as the following two conditions are true:

1. For each set of securities in which an order will be placed, there is a well-defined ordering of those securities. This ordering determines how the contingencies among the securities will be resolved.

2. There is a mechanism for handling non-contingent orders in at least some securities (though not necessarily all of them). That is, the process described below gives a method to “factor” out the common parts of two contingent orders, leaving zero, one or two “residuals.” If the residuals are themselves contingent, then the process continues, but if they are not contingent, then we have a couple of options. Consider that a non-contingent residual is effectively an order to buy or sell a single security. The Matcher might send these “residual orders” to an external market (e.g. NYSE) or to another person whose job it is to handle them, or it might have a set of rules that describe what to do with the residuals (e.g. if the size of the residual is small, then automatically match the residual order against the broker/dealer's account.) This can be configured differently for each security. There might not be any configuration or rules for a given security, however. In this case, there is nothing more the process can do: the residual order will never be executed, and any contingent matches that depended on this residual order will likewise never be completed.

The order matcher uses the ordering defined in Condition 1 to determine which contingencies to resolve first. In the above example, the ordering was defined as {convertible shares, common shares}; the order matcher first determines how the convertible portion of an order may be executed and uses this information to determine how to execute the common portion.

The contingent order matcher processes orders by reducing the number of securities, one at a time, in the ordering specified for those securities. A contingent order for n securities will be reduced to a new “order” involving n−1 securities. The new order will be a contingent order if n−1>1 and non-contingent order if n−1=1. Non-contingent orders will be handled using the mechanism in Condition 2, if any.

Finally, note that the mechanism introduced in Condition 2 may be external (e.g. ECNs or human beings with the authority to fill non-contingent orders) or internal to the contingent order matcher (e.g. a set of rules for determining what sorts of trades to execute to fulfill the order). If a contingent order is to be executed in a completely riskless manner, however, at most one external mechanism can be used in the course of resolving any of the residual orders, and this mechanism must also be riskless. By “external” it is meant, a mechanism beyond the control of the riskless contingent matcher. By ensuring that at most one external mechanism is used, it is meant eliminate risk by establishing a response for any possible action the mechanism might take. If it were to use two or more external mechanisms, however, it could not force one of those mechanisms to respond based on the actions of the other. For example, in the process of resolving the contingencies between two orders, say that it could (contrary to the reasoning here) decide to place two external stock orders. Once the second order has be placed, it can no longer meet the proportionality constraint: once one order executes, we cannot force the other to do the same.

In the convertible example above, the residual stock order was trivially riskless, since only a single security was sold, and therefore, there were no contingencies. In situations with more complex swaps (e.g. involving more securities) and where riskless matching is not a requirement, the Intelligent Markets contingent order matcher could be configured to use multiple external mechanisms; this would expose the participants to additional risk, often called legging risk. Where riskless matching is a requirement and there are more than two securities per order, the matcher could be configured to use internal mechanisms in all but the case of the last security. This configuration would ensure that all orders were executed in a riskless manner.

A further description of the invention is as follows:

A contingent order A is sent to the order matcher.

Let the securities included in A be (s1, s2, . . . , sn) where the ordering of the securities follows the ordering given in Condition 1 above.

The order matcher looks for a complementary order B with securities (s1, . . . , sm).

Note that B, must include s1, but not necessarily any of (s2, . . . , sn).

To be complementary, B must indicate the desire to buy s1 if A indicates the desire to sell s1 (and sell if A indicates the desire to buy). For example, consider an order to be a set of constraints on the possible trades that fulfill that order. For instance, a buy order constrains the direction of the possible trades; an order “to buy at $25 or less” constrains the price of those trades. Two orders are “complementary” if they differ in direction (e.g. one is a buy and the other a sell) AND there is at least one trade which meets the constraints of both. Another word might be “compatible,” but this, I think, doesn't convey the buy/sell relationship of the two orders.)

Even if A and B are complementary, as defined above, they may be only partially complementary. That is, the quantity of s1 that A offers for sale may be greater that the quantity bid by B. Again, consider an order as a set of constraints on possible trades. In the above language, we might have said that trade t satisfies the constraints of order A. It is possible that a set of trades (when taken together) will also satisfy an order. Say that t1 and t2, when taken together, also satisfy order A. If t1 alone would completely satisfy the constraints of B, then A and B are partially complementary. For example, say that A offers 2000 shares of s1 for sale, while B bids for only 1000 shares. A trade of 1000 shares completely satisfies B while only partially satisfying A; we would say in this case that A and B are partially complementary. In other words, that one order complements a portion of the other.

Let QA(s1) be the quantity of s1 offered (or bid)-by A, and let QB(s1) be the quantity of s1 bid (or offered) by B.

Let Q(s1)=min( QA(s1), QB(s1)), the overlapping portion of the two orders in s1. This is the largest amount of s1 that can be executed between A and B while still satisfying both orders.

The order matcher will attempt to execute the overlapping portion Q(s1) of s1 between A and B. However, it must first resolve the remaining contingencies.

These remaining contingencies may be written in the form of a pair of new orders, one for each of A and B.

Let A′ be the remainder of A. A′ includes securities (s2, . . . , sn).

Note that the quantities associated with each security in A′ may or may not be the same as those in A.

For example, one non-trivial method of computing QA′ is as follows:

$${Q}_{{A}^{′}} ( {s}_{i} ) = \frac{Q ( {s}_{1} )}{{Q}_{A} ( {s}_{1} )} {Q}_{A} ( {s}_{i} ) for i •2 , … , n$$

That is, execute the remaining securities in proportion to It will be appreciated that the “proportion” aspect is an important part a of what it means to be “riskless.” The only time that we relax the proportionality constraint is to account for some other constraint, for example, that all trades be even multiples of 100 shares, as described below the quantity of s1 to be executed between A and B.

Note that while B′ must be defined in the same manner as A′, it is not necessary equal to A′. The differences between A′ and B′ represent the incompatibilities in the contingencies of A and B.

Though A′ and B′ are defined as orders here, it should be understood that they are simply manifestations of the remaining contingencies and that they are only termed orders because they have many of the same attributes that characterize orders such as A and B.

As the remaining contingencies are executed, trades of s1 are executed between A and B. By “execute” an order, it is meant to create trades that satisfy that order. That is, to take what is an agreement to exchange one or more items and actually carry out that exchange.

Analogous to the proportionality constraint above, A and B may require that the executions of s1 are done in proportion to the executions of the other securities.

The process is repeated using A′ and B′ in place of A and B.

If at any time both A′ and B′ are empty (orders with no corresponding securities), all incompatibilities between A and B have been resolved and any remaining overlapping quantity may be executed.

If exactly one of A′ and B′ is empty, then the order matcher must use the mechanisms introduced in Condition 2 above to execute the remaining securities. If no such mechanism exists for one or more securities, then the order matcher gives up on B as a potential match for A.

If both A′ and B′ are non-empty and share none of their remaining securities, then the order matcher gives up on B as a potential match for A. Note that it is possible to write an order matcher that handles this case. However, it would no longer be a riskless contingent order matcher.

If a request to cancel either of the original orders, A and B, is made, then any orders representing the remaining contingencies A′ and B′ must also be canceled before the request for A or B can be satisfied. In addition, any external commitments as part of the mechanism in Condition 2) must also be retracted before the request can be satisfied. For example, if any residual orders have been sent to an external marketplace, these orders must be retracted before we can confirm that either A or B can been canceled. For example, consider the consequences if this order was not canceled: if B was allowed to cancel without retracting the residual order, then it would not be possible to handle any executions that were returned from the external marketplace in a riskless manner; A would be put at risk.

A and B may stipulate additional constraints (e.g. other than the quantity of each security to be traded). These constraints may take one of several forms. A constraint may apply to exactly one security (e.g. a limit price for that security) or they must be representable in terms of an additional “pseudo-security” (e.g. total cash spent in the transaction). By “applying to exactly one security” we mean that the constraint only limits the trades that occur in a single security. The limit price for security QQQ does not limit what trades we might execute in RRR. By making this simplification, the process can be streamlined tin such a way that it is efficiently implementable on a computer.

By “pseudo-security” it is meant, an item that, though it might not appear explicitly in a order, can be used to accurately model the constraints of that order. For example, in a swap order, a user might specify as a baseline that QQQ must be purchased at $25 and RRR sold at $20, but that the prices may vary as long at the price of RRR decreases by $2 for every $1 decrease in the price of QQQ. For example, the prices $20 for QQQ and $10 for RRR also meet the constraints of this order. Note that it is not necessarily evident that the constraints of this order can be phrased in one of the two forms above: the price constraint here affects both securities and is not a simple limit price constraint. However, if the order also specifies that the user would like to buy 2,000 shares of QQQ and sell 1,000 shares of RRR, we can describe the price constraint in a different way. Note that for each share of RRR that the user sells, she would like to buy two shares of QQQ using the proceeds of the RRR sale and an additional $30. Since there are 1000 shares of RRR altogether, we can say that the user desires to spend a total of $30,000 on this transaction. This “total cash spent in transaction” is an implicit item whose exchange is constrained by the order. Just is there is a maximum quantity of securities like QQQ and RRR, there is a maximum quantity of “total cash” to be exchanged, and that exchange must occur in proportion with the other securities. In this example, if we use a “total cash” constraint, there is no need for individual limit price constraints; however, users may with to use both “total cash” and limit price constraints in the same order.

Finally, the process may be configured to support additional constraints that apply to all securities in an order, such as the one mentioned above (enforcing the proportionality between trades in s1 and those in (s2, . . . , sn)) or requiring all trades to be of an integer multiple of lot size.

### EXAMPLES

### First Example

Alice places a contingent order to buy 2,000 shares of QQQ (at $25/share) while selling 1,000 shares of RRR (at $20/share).

If Bob places an order to sell 1,000 shares of QQQ at $25/share, then we can consider a partial execution of Alice's order. That is, we can execute half of Alice's order, assuming we can find a buyer for 500 shares of RRR. (This 500 shares is the residual order derived from a match between Alice and Bob.) Let's say we send an order to the NASDAQ market to sell 500 shares of RRR at $20 or better. Consider the following sequence of events:

We receive an execution from the NASDAQ market of 100 shares of RRR. We pass these shares of RRR along to Alice as we simultaneously execute a cross between Alice and Bob of 200 shares of QQQ at $25. The NASDAQ market has updated our outstanding order to reflect the execution, 400 shares remain. We, in turn, update Alice's order to 1800 shares of QQQ and 400 shares of RRR, and Bob's order to 800 shares of QQQ.

Bob decides to withdraw his order from the marketplace. He logs a request to cancel his order. Before his request can be satisfied, we must cancel the order sent to the NASDAQ market. We note Bob's request and send a request to the market to cancel our RRR order.

Before we receive a confirmation of our cancellation, we receive a second execution from the NASDAQ market; this time for 200 shares. Again, we pass this on to Alice and cross another 400 shares of QQQ between Alice and Bob. At this point Alice's order has 1400 shares of QQQ and 700 of RRR remaining; Bob's order has 400 shares of QQQ remaining.

Finally we receive confirmation of the cancellation NASDAQ RRR order. We cancel Bob's order, recording that we have filled 600 shares out of his original request for 1,000 shares. Note that at this point Alice's order is still active in the marketplace.

### Second Example

Instead of Bob, say that Carol entered an order instead. Say that Carol entered an order to sell 2,000 shares of QQQ (at $25/share) and buy 1500 shares of RRR (at $20/share). (Remember that Alice would like buy 2,000 shares of QQQ and sell 1,000 shares of RRR.)

In this case, the residual order derived from the Alice-Carol match is an order to buy 500 shares of RRR. Again, we place an order with the NASDAQ market, this time to buy 500 shares of RRR at $20 or better. Let's say that we receive a partial execution of 100 shares. We pass these 100 shares on to Carol and create two additional crosses. First we cross an additional 200 shares of RRR between Alice and Carol; then we cross 400 shares of QQQ. The current state of the orders can be described as follows: the NASDAQ order has 400 shares remaining, Alice's order has 1600 shares of QQQ and 800 shares of RRR remaining, finally, Carol's order has 1600 shares of QQQ and 1200 shares of RRR remaining. Note that for both Alice and Carol, the ratio between the number of shares of QQQ and RRR remaining is unchanged.

### Third Example

Now consider a more sophisticated order from Alice. Again, say that Alice would like to buy 2,000 shares of QQQ and sell 1,000 shares of RRR. Instead of specifying a limit price for each of the securities, say that Alice simply specifies that she is willing to spend $30,000 to complete the transaction. Note that the prices given above ($25 for QQQ and $20 for RRR) satisfy this constraint, but that other combinations of prices do also, for example, $30 for each share of QQQ and $30 for each share of RRR.

### Fourth Example

Now reconsider Carol's order from above (sell 2,000 shares QQQ, buy 1500 shares RRR). Again, rather than a set of limit prices, say that Carol simply requires that she gains $25,000 in completing her transaction. For example, she might sell QQQ at $23 and buy RRR at $14.

As above, the residual order derived from a match between Alice and Carol will be an order to buy 500 shares of RRR. In this case, however, since there is no limit price associated with the RRR portion of either order, we must compute the price of RRR that satisfies the constraints of both Alice and Carol. In this example, a price of $10 is sufficient. To see why, consider the following equations:

Total cash spent by Alice=cash spent on QQQ−cash gained on RRR=2,000 * $20−1,000 * $10=$30,000 Total cash gained by Carol=cash gained on QQQ−cash spent on RRR=2,000 * $20−1500 * $10=$25,000

Once we have computed the price of the residual order, we can send an order to the NASDAQ market to buy 500 shares of RRR at $10. As before, when an execution is received from the market, we execute crosses of QQQ and RRR between Alice and Carol.

### Fifth Example

Sometimes, participants may impose additional constraints on the matching process. For example, many participants may require that all executions be a multiple of 100 share lots. To see how this makes the problem more difficult, take another participant, Dave. Dave places an order to sell 2,000 shares of QQQ and buy 700 shares of RRR. Consider a match against Alice (buy 2,000 QQQ, sell 1,000 RRR) and ignore price constraints for the moment. The residual order is an order to sell 300 shares of RRR. Say that we route such an order and receive an execution of 100 shares. We would like to cross ⅓ of the 2,000 QQQ shares and 700 RRR shares, however in both cases, ⅓ is not a multiple of 100 shares. Instead we cross a quantity that is both a multiple of 100 shares and is also closest to ⅓: we cross 700 shares of QQQ and 200 shares of RRR (in addition to passing on the 100 shares of RRR sold externally to Alice). The current state of the orders can be summarized:

Alice: buy 1300 shares QQQ, sell 700 shares RRR

Dave: sell 1300 shares QQQ, buy 500 shares RRR

Finally, it is important that we allot the proper amount of cash to this set of executions. If Alice was willing to spent $30,000 on the entire transaction, then we should not allocate $10,000 for this transaction, despite the fact that we attempting to complete ⅓ of Alice's order. Instead we should allocate the cash based on the actual number of shares executed. If the match called for executions of QQQ at $25 and RRR at $20, then for this partial execution, we can safely allocate $11,500 (=700 * $25−300 * $20).

Operative Environment

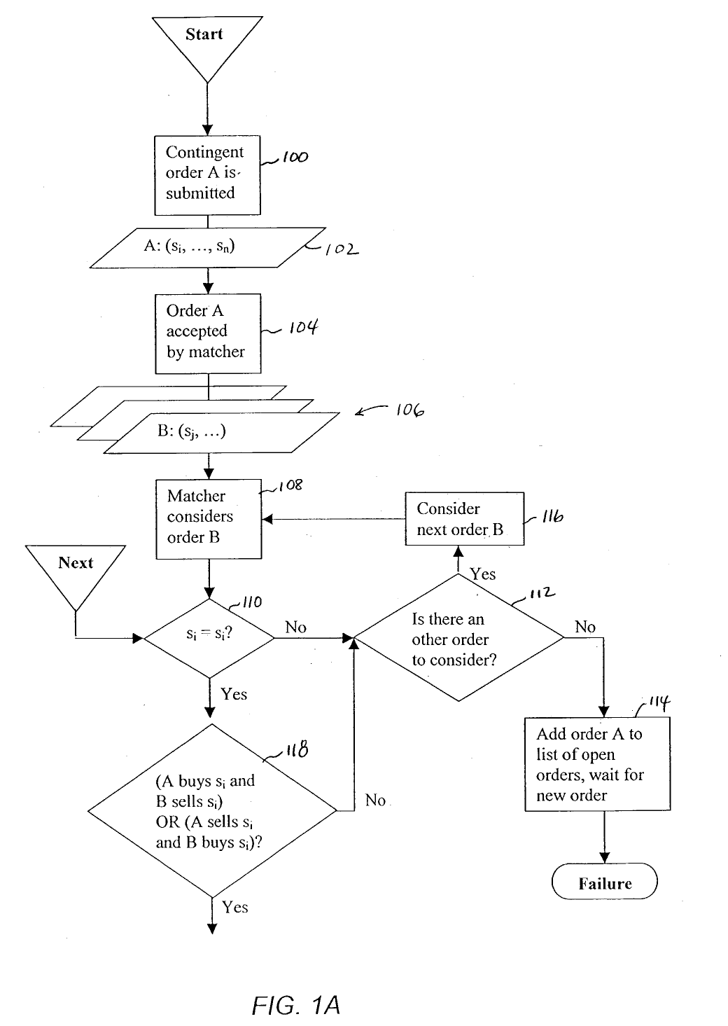

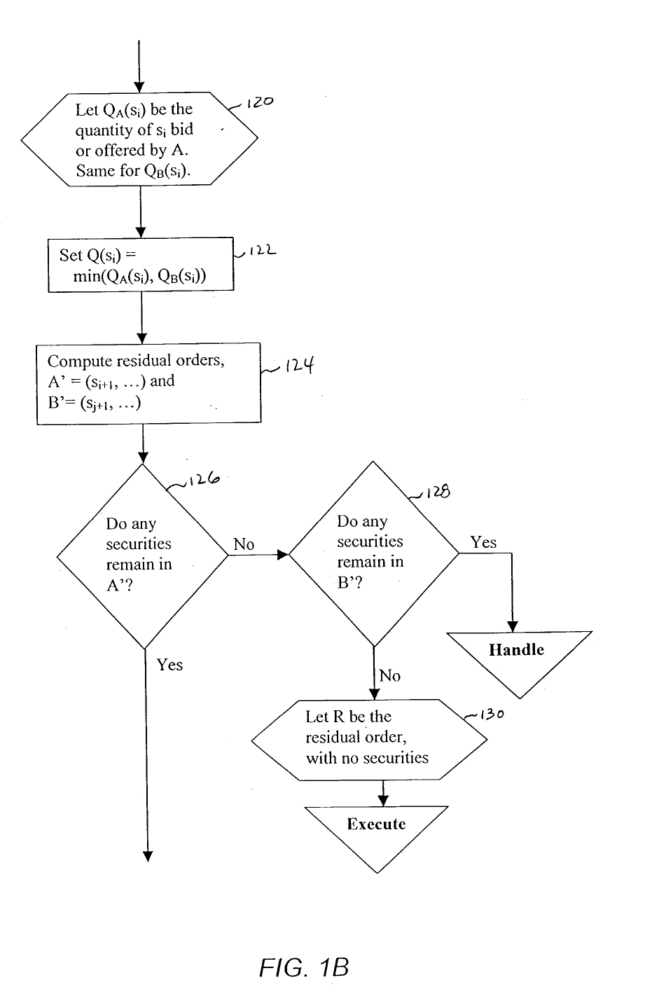

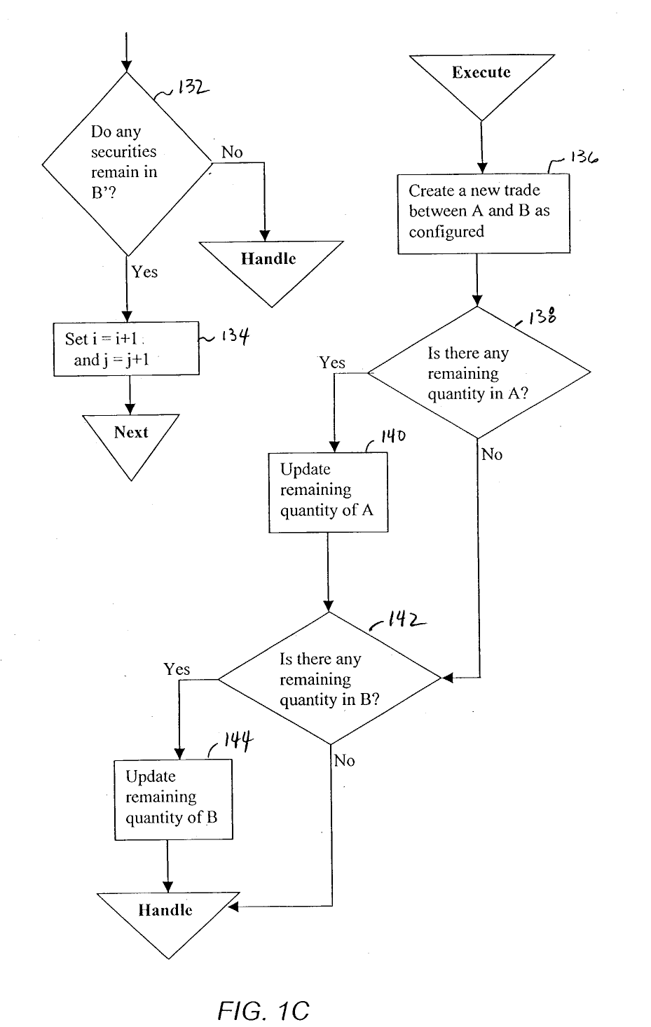

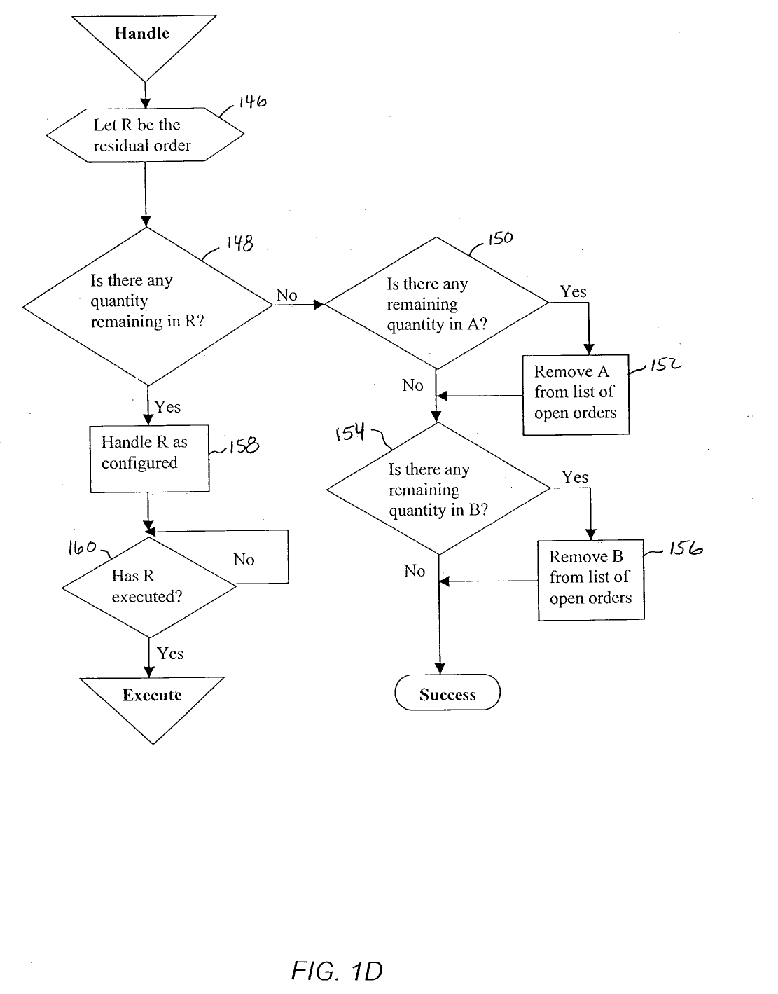

FIGS. 1A-1D are illustrative flow diagrams showing the operation of a computer program based process in accordance with one embodiment of the invention. Referring to FIG. 1A, in step 100 an order is loaded into a processing system such as an order processor with analytics capabilities. Block 102 indicates that the order may comprise multiple items <Si . . . Sn> such as financial instruments like securities, bonds or derivatives. In step 104 the order is accepted and verified. During this step, the order may be stored in an order database, for example. Blocks 106 indicate that there may be numerous previously received orders B<Sj . . .> already queued for processing. In step 108, one of the queued orders B, is selected form the queue. In decision step 110 a determination is made as to whether the first item in order A matches the first item in selected order B. In not, then in decision step 112 a determination is made as to whether there is another order in the queue to be compared with order A. If not, then in step 114 order A is added to the queue illustrated in block 106. Order A then awaits processing using subsequently received orders. If there is another order in queue 106 to be considered then in step 116 the next order is retrieved and processing returns to step 108. If in decision step 110 it is determined that the items do match, then in decision step 118 a determination is made as to whether the orders of A and B are in complementary directions. If not, then the process transitions to decision step 112.

Referring to FIG. 1B, if the directions of the orders in the first two items in A and B are complementary, then the process transitions to step 120 in which a determination is made as to the quantity of the identified matching item of orders A and B. In step 122, the smaller of the two quantities is selected. In step 124, new order A′ and new order B′ are calculated. These new orders focus on the next-in-order items in orders A and B. The new order A′ maintain the proportionality among items in order A′ as defined under the rules for order A so as to minimize risk. The new order B′ maintains proportionality among items in order B′ as defined under the rules for order B so as to minimize risk. In decision step 126, a determination is made as to whether there are any additional items in a new order A′. If not, then in step 128, a determination is made as to whether there are additional items in new order B′. If not, then in step 130, a new residual order is created with no securities.

Referring to FIG. 1C, if in decision step 126, a determination is made that new order A′ does have remaining items, then in decision step 132, a determination is made as to whether any items remain in new order B′. If so, then in step 134, there is a move to the next item in each of orders A′ and B′.

Referring to FIGS. 1A-D, it will be noted that various steps branch to a computer program process called, ‘Execute’. FIG. 1C includes an illustrative flow diagram of the ‘Execute’ process. Step 136 creates a new trade between orders A, B (or in orders A′, B′, etc.). Steps 138-144 serve to update each item in orders A, B or in orders A′, B′, etc until the current state of orders A and B as represented in the database reflects the latest trade.

Referring to FIGS. 1A-D, it will be noted that various steps branch to a computer program process called, ‘Handle’. FIG. 1D includes an illustrative flow diagram of the ‘Handle’ process. Block 146 represents a residual order R. Decision step 148 determines whether there is any quantity of item remaining in the residual order R. If not, then a determination is made as to whether there is any quantity of item remaining in order A. If so, then step 152 removes A from the list of open orders and the process moves to step 154. If not, then the process moves to step 154 in which a determination is made as to whether there is any quantity of item remaining in order B. If so, then step 156 removes B from the list of open orders. If in decision step 148 it is determined that there is quantity of an item remaining in R, then in step 158, R is submitted to an electronic marketplace. Step 160 represents a wait loop in which acceptance of the residual order is awaited.

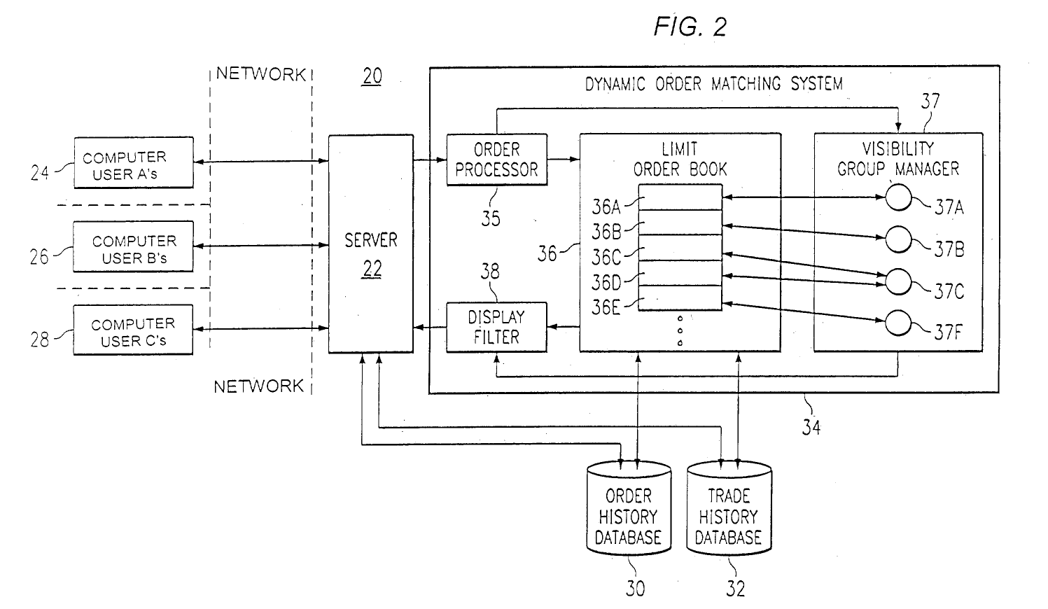

FIG. 2 shows a network for one system to implement a multi-tier order matcher in accordance with the present invention. A system 20 has a network server 22, which works through a variety of networks for connection with user desktop clients such as 24, 26 and 28. The system and method of the present invention may utilize several data files including an order history database 30 and a trade history database 32 which are connected to the network server 22. A dynamic order matching system 34 is included in the system 20 for dynamically matching orders that are entered into the system 20, and for controlling display of these orders on web desktop clients 24, 26, and 28. A dynamic order matching system is described in commonly owned U.S. patent application Ser. No. 09/386,436, entitled Dynamic Order Visibility System for the Trading of Assets, which is expressly incorporated herein in its entirety by this reference. The system 20 enables users to place orders (buy or sell) through their web desktop clients and specify a visibility group of other system users (market participants) who will have access to the order. Further databases, order matching and definitions of visibility groups are described below in detail.

The dynamic order matching system 34 includes an order processor 35 that is connected to the network server 22. The processor 35 is further connected to a limit order book 36 and a visibility group manager 37. The order processor 35 can receive the contingent orders and process them to manage contingencies in accordance with the process of FIGS. 1A-1D. A display filter 38 is connected to the limit order book 36, the visibility manager 37 and to the network server 22. The function of the display filter 38 is to insure that a given order is made available only to the participants in a selected visibility group. Therefore, it is responsible for constructing the complete list of visible orders for each user.

The limit order book 36 includes specific orders 36A, 36B, 36C, 36D and 36E. Visibility groups, which are designated sets of participants, are included in the visibility group manager 37 as 37A, 37B, 37C and 37F. Order 36A is associated with visibility group 37A, order 36B is associated with visibility group 37B and both of the orders 36C and 36D are associated with the visibility group 37C. Order 36E is associated with visibility group 37F.

The order database 30 and trade history database 32 are further coupled to the limit order book 36.

The dynamic order matching system 34 and its included components, together with the databases 30 and 32, can be implemented in either a single processing system or a distributed system of processors.

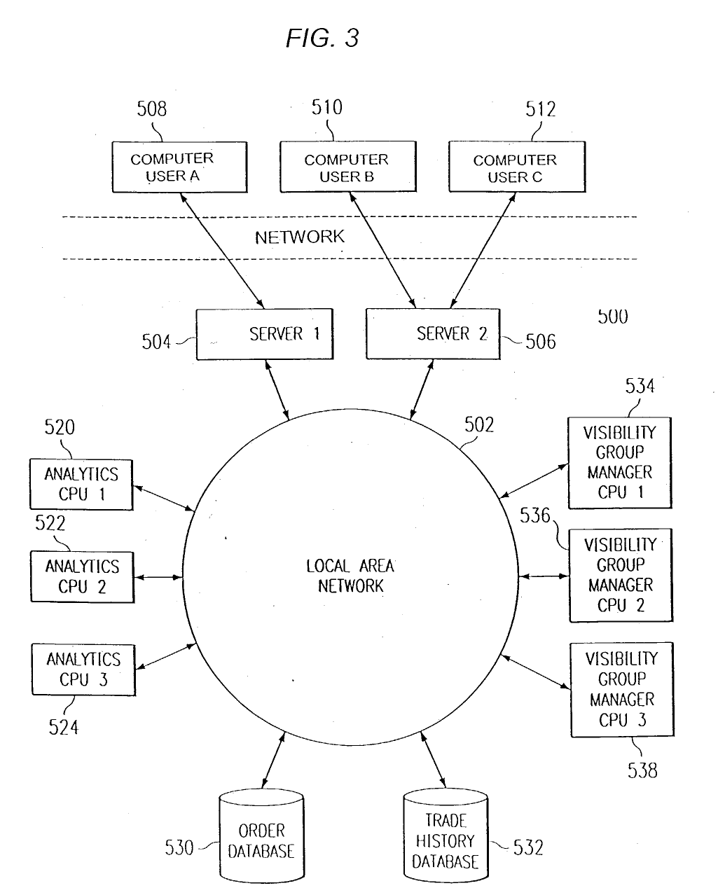

An alternative network 500 to implement a multi-tier order matcher in accordance with the present invention is shown in FIG. 3. This works with the Internet and has user desktop clients 508, 510 and 512 which correspond to the user desktop clients shown in FIG. 2.

A network 500 has network servers 504 and 506 that interconnect the local area network 502 through the Internet to each of the Web desktop clients 508, 510 and 512.

Three analytic engines 520, 522 and 524 connect to the local area network 502. In this example, these correspond to the analytic engines 39A, 39B and 39C shown in FIG. 2. The analytics engines can be programmed to process contingent orders in accordance with FIGS. 1A-1C. In other configurations, however, there might be multiple analytics engines per CPU, or multiple CPUs per analytics engine. An order database 530 corresponds to the database 30 shown in FIG. 2 and a trade history database 532 corresponds to the database 32 shown in FIG. 2. The network 500 includes three visibility group managers 534, 536 and 538 for generating visibility groups. Although network 500 is a representative hardware configuration of the present invention, the distribution of functions and data storage can be arranged in many different configurations as needed and as determined by the availability of resources for implementing the functions required for the present invention.

It will be understood that the foregoing description and drawings of preferred embodiments in accordance with the present invention are merely illustrative of the principles of the invention. Various modifications can be made by those skilled in the art without departing from the spirit and scope of the invention.

What is claimed is:

1. A computer-implemented method of matching orders comprising:
defining a first order for a first item;
defining a second order for a second item;
defining at least one condition applicable to combined execution of the first and second orders;
wherein the at least one condition sets forth a required proportionality measure as between the first order and the second orders;
defining a prioritization of first and second orders; and
submitting to an electronic marketplace at most one at a time of a new order of only an item of the first order or only an item of the second order:
wherein execution of both the first order and the second order meets the conditions applicable to the execution of the first and second orders; and
wherein execution of both the first order and the and second order is contingent upon the execution of the at least one order submitted over the electronic marketplace.
